(19) United States
(12) Patent Application Publication
(10) Pub. No.: US 2004/0246312 A1
(43) Pub. Date: Dec. 9, 2004

(54) LIQUID-JET HEAD, METHOD OF MANUFACTURING THE SAME AND LIQUID-JET APPARATUS

(75) Inventors: Souichi MORIYA, NAGANO-KEN (JP); Masato SHIMADA, NAGANO-KEN (JP); Shiro YAZAKI, NAGANO-KEN (JP); Tsutomu NISHIWAKI, NAGANO-KEN (JP); Masami MURAI, NAGANO-KEN (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, Tokyo (JP)

(21) Appl. No.: 10/710,261

(22) Filed: Jun. 29, 2004

Related U.S. Application Data
(62) Division of application No. 10/278,026, filed on Oct. 23, 2002.

(30) Foreign Application Priority Data
Oct. 26, 2001 (JP) 2001-329608
Jan. 30, 2002 (JP) 2002-021875
Oct. 16, 2002 (JP) 2002-302308

(51) Int. Cl. B41J 2/045

(52) U.S. Cl. 347/68

(57) ABSTRACT

A liquid-jet head capable of preventing malfunction attributable to an external environment such as humidity of a piezoelectric element and of achieving miniaturization thereof, a manufacturing method thereof and a liquid-jet apparatus are disclosed. The liquid-jet head including a passage-forming substrate in which a pressure generating chamber communicating with a nozzle orifice ejecting a liquid is defined and a piezoelectric element composed of a lower electrode, a piezoelectric layer and an upper electrode on one surface of the passage-forming substrate with a vibration plate interposed therebetween, wherein the liquid-jet head includes a sealing plate joined to a piezoelectric element side of the passage-forming substrate and having a piezoelectric element holding portion, the sealing plate hermetically sealing a space secured in a region facing to the piezoelectric element to an extent not to hinder a movement thereof, and at least a part of a peripheral portion of the piezoelectric element holding portion of the sealing plate is joined to the passage-forming substrate via a glass joining layer made of glass. Thus, intrusion of moisture into the piezoelectric element holding portion is prevented.

### CROSS-REFERENCE TO RELATED APPLICATIONS

This is a Division of U.S. application Ser. No. 10/278,026, filed 2002-10-23, the disclosure of which is incorporated herein by reference, in its entirety, for all purposes

### BACKGROUND OF THE INVENTION

1. Field of the Invention

The present invention relates to a liquid-jet head which ejects jets of liquid, a manufacturing method thereof and a liquid-jet apparatus. More particularly, the present invention relates to an ink-jet recording head which ejects ink droplets by displacement of piezoelectric elements formed on surfaces of vibration plates partially constituting pressure generating chambers communicating with nozzle orifices ejecting ink droplets, to a manufacturing method thereof and to an ink-jet recording apparatus.

2. Description of the Related Art

In an ink-jet recording head, in which pressure generating chambers that communicate with nozzle orifices ejecting ink droplets are partially constituted of vibration plates, these vibration plates are deformed by piezoelectric elements to pressurize ink in the pressure generating chambers, and the ink droplets are ejected from the nozzle orifices, two types of recording heads are put into practical use. One is a recording head using piezoelectric actuators of a longitudinal vibration mode, which expand and contract in an axis direction of the piezoelectric elements, and the other is a recording head using piezoelectric actuators of a flexural vibration mode.

In the former type, a volume of each pressure generating chamber can be changed by abutting an end surface of the piezoelectric element against the vibration plate, and manufacturing of a head suitable to high density printing is enabled. However, this requires a difficult process of cutting and dividing the piezoelectric element in a comb tooth shape in accordance with an array pitch of the nozzle orifices and work to position and fix the cut and divided piezoelectric elements to the pressure generating chambers. Thus, there is a problem of a complex manufacturing process.

On the other hand, in the latter type, the piezoelectric elements can be fabricated and installed on the vibration plate by a relatively simple process of adhering a green sheet as a piezoelectric material while fitting a shape thereof to that of the pressure generating chambers and sintering the green sheet. However, a certain area of the vibration plate is required due to use of the flexural vibration, thus there is a problem that achieving a high density array of the piezoelectric elements is difficult.

Meanwhile, in order to solve such a disadvantage of the latter recording head, a recording head is proposed, in which an even piezoelectric material layer is formed over the entire surface of a vibration plate by a deposition technology, the piezoelectric material layer is cut and divided into a shape corresponding to that of pressure generating chambers by a lithography method, and piezoelectric elements are formed so as to be independent of each other for each pressure generating chamber (refer to, for example, Japanese Patent Laid-Open No. Hei 5 (1993)-286131, Page 3, FIG. 3).

The recording head described above has the following advantage. The work of adhering the piezoelectric elements to the vibration plate is eliminated, and the piezoelectric elements can be fabricated and installed by the precise and simple method that is the lithography method. In addition, a thickness of each piezoelectric actuator can be thinned to enable a high-speed drive.

However, in the case of the ink-jet recording head having the piezoelectric elements constituted of the piezoelectric material by sputtering as described above, when the inkjet recording head is driven by a voltage approximately the same as that of the one constituted by sintering the green sheet, the thinner the piezoelectric elements are, the higher the electric field to be applied thereto. Thus, when the recording head absorbs moisture in the atmosphere, there is a problem that a leak current between drive electrodes is likely to increase, eventually leading to dielectric breakdown.

In order to solve the problems as described above, a constitution is proposed, in which a reservoir-forming plate is adhered to a passage-forming substrate on which pressure generating chambers are formed, the reservoir-forming plate having a piezoelectric element holding portion for sealing piezoelectric elements (refer to, for example, Japanese Patent Laid-Open No. 2000-296616, Page 9, FIGS. 1 and 2).

### SUMMARY OF THE INVENTION

However, regarding the constitution in which the reservoir-forming plate having the piezoelectric element holding portion is adhered to the passage-forming substrate, there is a problem that moisture intrudes into the piezoelectric element holding portion through an adhesive adhering the reservoir-forming plate to the passage-forming substrate, thus leading to damage of the piezoelectric elements.

Moreover, intrusion of moisture into the piezoelectric element holding portion can be suppressed by increasing an adhesion area between the reservoir-forming plate and the passage-forming substrate. However, there is a problem that the size of the recording head is inevitably increased.

Note that, naturally, a similar subject to the above-described one exists not only in a method of manufacturing the ink-jet recording head ejecting ink droplets but also in a method of manufacturing another liquid-jet head ejecting a liquid other than ink.

In consideration of circumstances as described above, the object of the present invention is to provide a liquid-jet head capable of preventing malfunction of the piezoelectric elements attributable to an external environment such as moisture and achieving miniaturization thereof, a manufacturing method thereof and a liquid-jet apparatus.

A first aspect of the present invention that attains the foregoing object is a liquid-jet head including a passage-forming substrate in which a pressure generating chamber communicating with a nozzle orifice ejecting a liquid is defined and a piezoelectric element composed of a lower electrode, a piezoelectric layer and an upper electrode on one surface of the passage-forming substrate with a vibration plate interposed therebetween, the liquid-jet head comprising: a sealing plate joined to a piezoelectric element side of the passage-forming substrate and having a piezoelectric element holding portion, the sealing plate hermetically sealing a space secured in a region facing towards the piezoelectric element in such a way that it does not hinder a movement thereof, wherein at least a part of a peripheral portion of the piezoelectric element holding portion of the sealing plate is joined to the passage-forming substrate via a glass joining layer made of glass.

In the first aspect, moisture from the outside, such as that in the atmosphere, never intrudes into the piezoelectric element holding portion via the glass joining layer, thus preventing damage to the piezoelectric element attributable to the moisture.

A second aspect of the present invention is the liquid-jet head according to the first aspect, characterized in that the sealing plate has a reservoir portion constituting at least a part of a common liquid chamber for each pressure generating chamber, and the glass joining layer is provided at least on a side of the reservoir portion in a peripheral portion of the piezoelectric element holding portion.

In the second aspect, moisture from the reservoir portion never intrudes into the piezoelectric element holding portion via the glass joining layer, thus preventing damage to the piezoelectric element attributable to the moisture.

A third aspect of the present invention is the liquid-jet head according to any one of the first and second aspects, characterized in that the glass joining layer is provided over at least the peripheral portion of the piezoelectric element holding portion on ajoining surface between the sealing plate and the passage-forming substrate.

In the third aspect, moisture from the outside, such as that in the atmosphere or in the reservoir portion, never intrudes into the piezoelectric element holding portion via the glass joining layer, thus preventing damage to the piezoelectric element attributable to the moisture.

A fourth aspect of the present invention is the liquid-jet head according to any one of the first to third aspects, characterized in that the glass joining layer is formed over an entire surface of the joining surface between the sealing plate and the passage-forming substrate.

In the fourth aspect, the intrusion of the moisture into the piezoelectric element holding portion via the glass joining layer is more surely prevented, and the damage to the piezoelectric element attributable to the moisture is prevented.

A fifth aspect of the present invention is the liquid-jet head according to any one of the first to fourth aspects, characterized in that the glass joining layer is formed over an inner surface of the piezoelectric element holding portion.

In the fifth aspect, the glass joining layer made of glass can be formed easily at relatively low costs.

A sixth aspect of the present invention is the liquid-jet head according to any one of the first to fifth aspects, characterized in that the glass constituting the glass joining layer is formed by sputtering or vacuum evaporation.

In the sixth aspect, by sputtering or vacuum evaporation, the glass joining layer made of glass can be formed easily at relatively low costs. Moreover, a thickness of the glass joining layer can be controlled relatively easily, thus improving yields and reducing the costs.

A seventh aspect of the present invention is the liquid-jet head according to any one of the first to sixth aspects, characterized in that the glass, constituting the glass joining layer is formedby screen printing or coating.

In the seventh aspect, the glass joining layer can be formed relatively easily at a high precision.

An eighth aspect of the present invention is the liquid-jet head according to any one of the first to seventh aspects, characterized in that a melting point of the glass constituting the glass joining layer is in a range of 200 to 700 oc.

In the eighth aspect, the passage-forming substrate and the sealing plate can be joined together at a relatively low temperature, thus enabling both plates to be joined satisfactorily without damage to the piezoelectric element due to heat generated in the joining thereof.

A ninth aspect of the present invention is the liquid-jet head according to any one of the first to eighth aspects, characterized in that a thickness of the glass joining layer is in a range of 0.5 to 10 mm.

In the ninth aspect, even if a drawn-out electrode to be drawn out from the piezoelectric element is formed, the passage-forming substrate and the sealing plate can be satisfactorily joined together.

A tenth aspect of the present invention is the liquid-jet head according to any one of the first to ninth aspects, characterized in that the glass constituting the glass joining layer contains a gettering agent for trapping moisture.

In the tenth aspect, moisture remaining in the piezoelectric element holding portion is trapped by the gettering agent contained in the glass joining layer, thus leaving the inside of the piezoelectric element holding portion in a dry state.

An eleventh aspect of the present invention is the liquid-jet head according to the tenth aspect, characterized in that the gettering agent contains phosphorous.

In the eleventh aspect, since phosphorous is particularly excellent in a function of trapping moisture, the piezoelectric element holding portion is surely in the dry state.

A twelfth aspect of the present invention is the liquid-jet head according to any one of the first to eleventh aspects, characterized in that the glass constituting the glass joining layer contains a filler.

In the twelfth aspect, by joining the passage-forming substrate and the sealing plate by use of the glass joining layer containing the filler, thermal expansion coefficient of the glass joining layer is made to be equal to that of the passage-forming substrate, and thus damage thereof due to thermal deformation can be prevented as well as the glass joining layer can be formed relatively thick. Moreover, a joining strength therebetween can be improved by the glass joining layer.

A thirteenth aspect of the present invention is the liquid-jet head according to the twelfth aspect, characterized in that the filler is made of at least one kind selected from a group including titania, zirconia and alumina.

In the thirteenth aspect, by allowing the glass joining layer to contain a predetermined filler, thermal expansion coefficient of the glass joining layer is made to be equal to those of the passage-forming substrate relatively easily, and the joining strength therebetween can be improved.

A fourteenth aspect of the present invention is the liquid-jet head according to any one of the first to thirteenth aspects, characterized in that the passage-forming substrate and the sealing plate are made of a single crystal silicon substrate.

In the fourteenth aspect, the passage-forming substrate and the sealing plate can be satisfactorily joined together without occurrence of any cracks.

A fifteenth aspect of the present invention is the liquid-jet head according to any one of the first to fourteenth aspects, characterized in that crystals are subjected to priority orientation in the piezoelectric layer.

In the fifteenth aspect, the piezoelectric layer is formed in a deposited process, and as a result, the crystals thereof are subjected to priority orientation.

A sixteenth aspect of the present invention is the liquid-jet head according to the fifteenth aspect, characterized in that the piezoelectric layer has crystals in a columnar shape.

In the sixteenth aspect, the piezoelectric layer is formed in a deposited process, and as a result, the crystals thereof are in the columnar shape.

A seventeenth aspect of the present invention is the liquid-jet head according to any one of the first to sixteenth aspects, characterized in that the pressure generating chamber is formed by anisotropic etching, and respective layers of the piezoelectric element are formed by a deposited deposited process and a lithography method.

In the seventeenth aspect, a liquid-jet recording head having nozzle orifices in high density can be manufactured in large quantity and relatively easily.

An eighteenth aspect of the present invention is a liquid-jet apparatus characterized by comprising the liquid-jet head according to any one of the first to seventeenth aspects.

In the eighteenth aspect, a liquid-jet apparatus can be realized, in which damage to the head is prevented, and durability and reliability are improved.

A nineteenth aspect of the present invention is a method of manufacturing a liquid-jet head including: a passage-forming substrate in which a pressure generating chamber communicating with a nozzle orifice ejecting a liquid is defined; a piezoelectric element composed of a lower electrode, a piezoelectric layer and an upper electrode on one surface of the passage-forming substrate with a vibration plate interposed therebetween; and a sealing plate joined to a piezoelectric element side of the passage-forming substrate and having a piezoelectric element holding portion, the sealing plate hermetically sealing a space secured in a region facing toward the piezoelectric element in such a way that it does not hinder a movement thereof, the method comprising the steps of: providing a glass joining layer made of glass in at least a part of a peripheral portion of the piezoelectric element holding portion on at least any one of joining surfaces of the sealing plate and the passage-forming substrate; joining the passage-forming substrate and the sealing plate with the glass joining layer interposed therebetween, by heating the plates to a predetermined temperature in a state wherein the two plates abuts each other with the glass joining layer interposed therebetween.

In the nineteenth aspect, the passage-forming substrate and the sealing plate can be satisfactorily-joined together by preventing intrusion of moisture into the piezoelectric element holding portion. Moreover, both plates can be satisfactorily-joined together at a relatively small area, thus enabling miniaturization of the liquid-jet head to be achieved.

A twentieth aspect of the present invention is the method of manufacturing a liquid-jet head according to the nineteenth aspect, characterized in that, in the step of forming the glass joining layer, the glass joining layer is formed at a side of a reservoir portion constituting at least a part of a common liquid chamber of each pressure generating chamber provided on the sealing plate at least in the peripheral portion of the piezoelectric element holding portion.

In the twentieth aspect, moisture from the reservoir portion never intrudes into the piezoelectric element holding portion via the glass joining layer, and damage to the piezoelectric element attributable to the moisture is prevented.

A twenty-first aspect of the present invention is the method of manufacturing a liquid-jet head according to any one of the nineteenth and twentieth aspects, characterized in that, in the step of forming the glass joining layer, the glass joining layer is formed over at least the peripheral portion of the piezoelectric element holding portion.

In the twenty-first aspect, moisture from the outside, such as in the atmosphere and the reservoir portion, never intrudes into the piezoelectric element holding portion via the glass joining layer, and the damage to the piezoelectric element attributable to the moisture is prevented.

A twenty-second aspect of the present invention is the method of manufacturing a liquid-jet head according to any one of the nineteenth to twenty-first aspects, characterized in that, in the step of forming the glass joining layer, the glass joining layer is formed over an entire surface of the joining surface.

In the twenty-second aspect, the intrusion of the moisture into the piezoelectric element holding portion via the glass joining layer is more surely prevented, and the damage to the piezoelectric element attributable to the moisture is prevented.

A twenty-third aspect of the present invention is the method of manufacturing a liquid-jet head according to any one of the nineteenth to twenty-second aspects, characterized in that, in the step of forming the glass joining layer, the glass joining layer is provided over the joining surface of the sealing plate and an inner surface of the piezoelectric element holding portion.

In the twenty-third aspect, the glass joining layer made of glass can be formed easily at relatively low costs.

A twenty-fourth aspect of the present invention is the method of manufacturing a liquid-jet head according to any one of the nineteenth to twenty-third aspects, characterized by further including, after the step of forming the glass joining layer, a step of doping the glass joining layer with a gettering agent for trapping moisture.

In the twenty-fourth aspect, the glass joining layer containing the gettering agent can be formed relatively easily by doping.

A twenty-fifth aspect of the present invention is the method of manufacturing a liquid-jet head according to any one of the nineteenth to twenty-third aspects, characterized in that, in the step of forming the glass joining layer, a glass joining layer added with a gettering agent for trapping moisture is formed.

In the twenty-fifth aspect, the glass joining layer containing the gettering agent can be formed relatively easily.

A twenty-sixth aspect of the present invention is the method of manufacturing a liquid-jet head according to any one of the twenty-fourth and twenty-fifth aspects, characterized in that the gettering agent contains phosphorous.

In the twenty-sixth aspect, phosphorous is optimal as the gettering agent since phosphorous is particularly excellent in a function of trapping moisture.

A twenty-seventh aspect of the present invention is the method of manufacturing a liquid-jet head according to any one of the nineteenth to twenty-sixth aspects, characterized in that a melting point of the glass constituting the glass joining layer is in a range of 200 to 700° C.

In the twenty-seventh aspect, the passage-forming substrate and the sealing plate can be joined together at a relatively low temperature, thus enabling both plates to be joined satisfactorily without occurrence of any cracks in the passage-forming substrate and the like.

A twenty-eighth aspect of the present invention is the method of manufacturing a liquid-jet head according to any one of the nineteenth to twenty-seventh aspects, characterized in that, in the step of providing the glass joining layer, the glass is formed by sputtering or vacuum evaporation.

In the twenty-eighth aspect, by sputtering or vacuum evaporation, the glass joining layer made of glass can be formed easily at relatively low costs. Moreover, a thickness of the glass joining layer can be controlled relatively easily, thus improving yields and reducing costs.

A twenty-ninth aspect of the present invention is the method of manufacturing a liquid-jet head according to any one of the nineteenth to twenty-seventh aspects, characterized in that, in the step of providing the glass joining layer, the glass is formed by screen printing or coati ng.

In the twenty-ninth aspect, the glass joining layer can be formed relatively easily with a high precision.

A thirtieth aspect of the present invention is the method of manufacturing a liquid-jet head according to any one of the nineteenth to twenty-ninth aspects, characterized in that the step of providing the glass joining layer includes a step of subjecting the glass to preliminary baking.

In the thirtieth aspect, the passage-forming substrate and the sealing plate can be satisfactorily joined together with a high precision.

A thirty-first aspect of the present invention is the method of manufacturing a liquid-jet head according to any one of the nineteenth to thirtieth aspects, characterized in that, in the step of forming the glass joining layer, a glass joining layer containing a filler is formed.

In the thirty-first aspect, by joining the passage-forming substrate and the sealing plate by use of the glass joining layer containing the filler, thermal expansion coefficient of the glass joining layer is made to be equal to that of the passage-forming substrate, and thus damage thereof due to thermal deformation can be prevented as well as the glass joining layer can be formed relatively thick. Moreover, a joining strength therebetween can be improved by the glass joining layer.

A thirty-second aspect of the present invention is the method of manufacturing a liquid-jet head according to the thirty-first aspect, characterized in that the filler is made of at least one selected from a group including titania, zirconia and alumina.

In the thirty-second aspect, by allowing the glass joining layer to contain the filler, thermal expansion coefficient of the glass joining layer is made to be equal to that of the passage-forming substrate relatively easily, and a joining strength therebetween can be improved.

A thirty-third aspect of the present invention is the method of manufacturing a liquid-jet head according to any one of the nineteenth to thirty-second aspects, characterized in that, after the step of joining the sealing plate and the passage-forming substrate, the piezoelectric element holding portion is hermetically sealed by sealing a sealing hole communicating the piezoelectric element holding portion of the sealing plate with the outside.

In the thirty-third aspect, the piezoelectric element holding portion can be hermetically sealed easily and surely by the sealing hole.

### BRIEF DESCRIPTION OF THE DRAWINGS

FIG. 1 is a perspective view schematically showing an inkjet recording head according to Embodiment 1 of the present invention.

FIGS. 2A and 2B are a plan view and a cross-sectional view showing the ink-jet recording head according to Embodiment 1 of the present invention, respectively.

FIGS. 3A to 3D are cross-sectional views showing steps of manufacturing the ink-jet recording head according to Embodiment 1 of the present invention.

FIGS. 4A to 4C are cross-sectional views showing the steps of manufacturing the ink-jet recording head according to Embodiment 1 of the present invention.

FIGS. 5A and 5B are cross-sectional views showing the steps of manufacturing the ink-jet recording head according to Embodiment 1 of the present invention.

FIGS. 6A and 6B are cross-sectional views showing the steps of manufacturing the ink-jet recording head according to Embodiment 1 of the present invention.

FIGS. 7A and 7B are a plan view and a cross-sectional view showing an ink-jet recording head according to Embodiment 2 of the present invention.

FIGS. 8A and 8B are cross-sectional views showing steps of manufacturing the ink-jet recording head according to Embodiment 2 of the present invention.

FIGS. 9A to 9C are cross-sectional views showing the steps of manufacturing the ink-jet recording head according to Embodiment 3 of the present invention.

FIGS. 10A and 10B are cross-sectional views showing steps of manufacturing an ink-jet recording head according to Embodiment 4 of the present invention.

FIGS. 11A and 11B are cross-sectional views showing steps of manufacturing an ink-jet recording head according to Embodiment 5 of the present invention.

FIGS. 12A and 12B are a plan view and a cross-sectional view showing the ink-jet recording head according to Embodiment 6 of the present invention.

FIG. 13 is a schematic view of an ink-jet recording apparatus according to an embodiment of the present invention.

### DESCRIPTION OF THE PREFERRED EMBODIMENTS

The present invention will be described below in detail based on an embodiment.

(Embodiment 1)

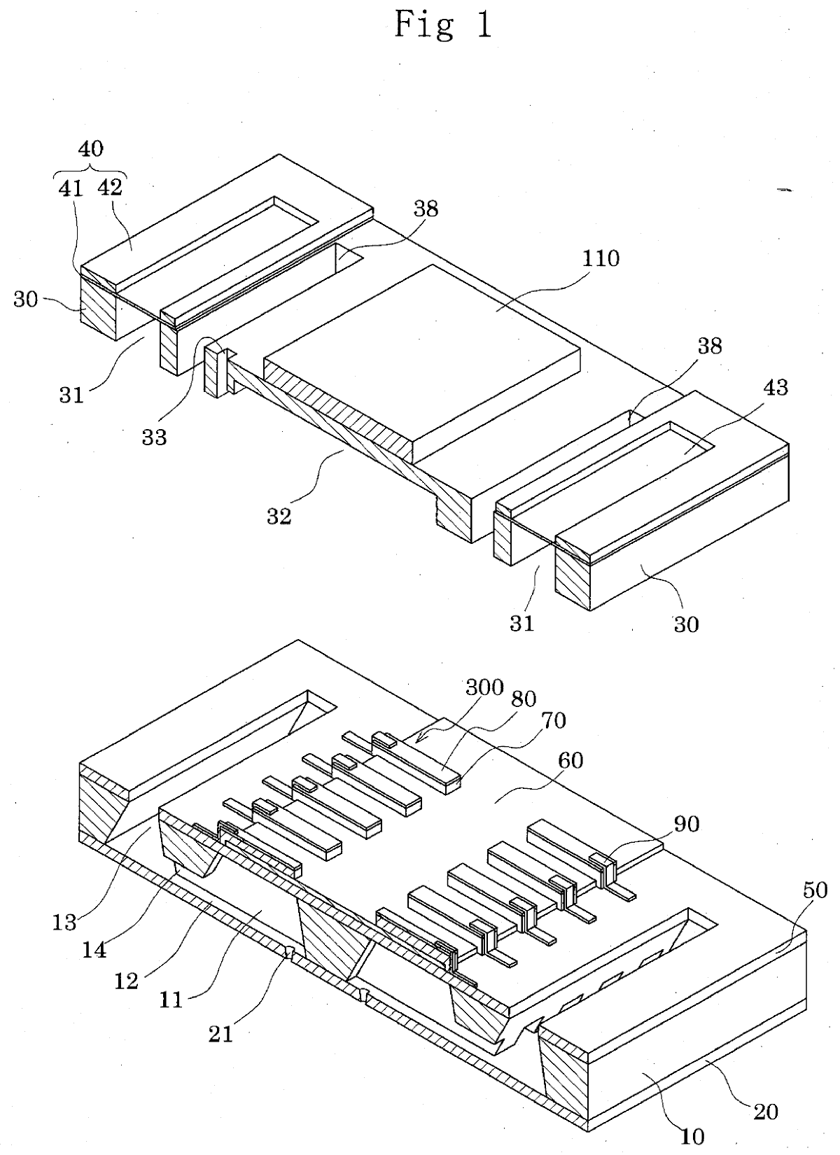

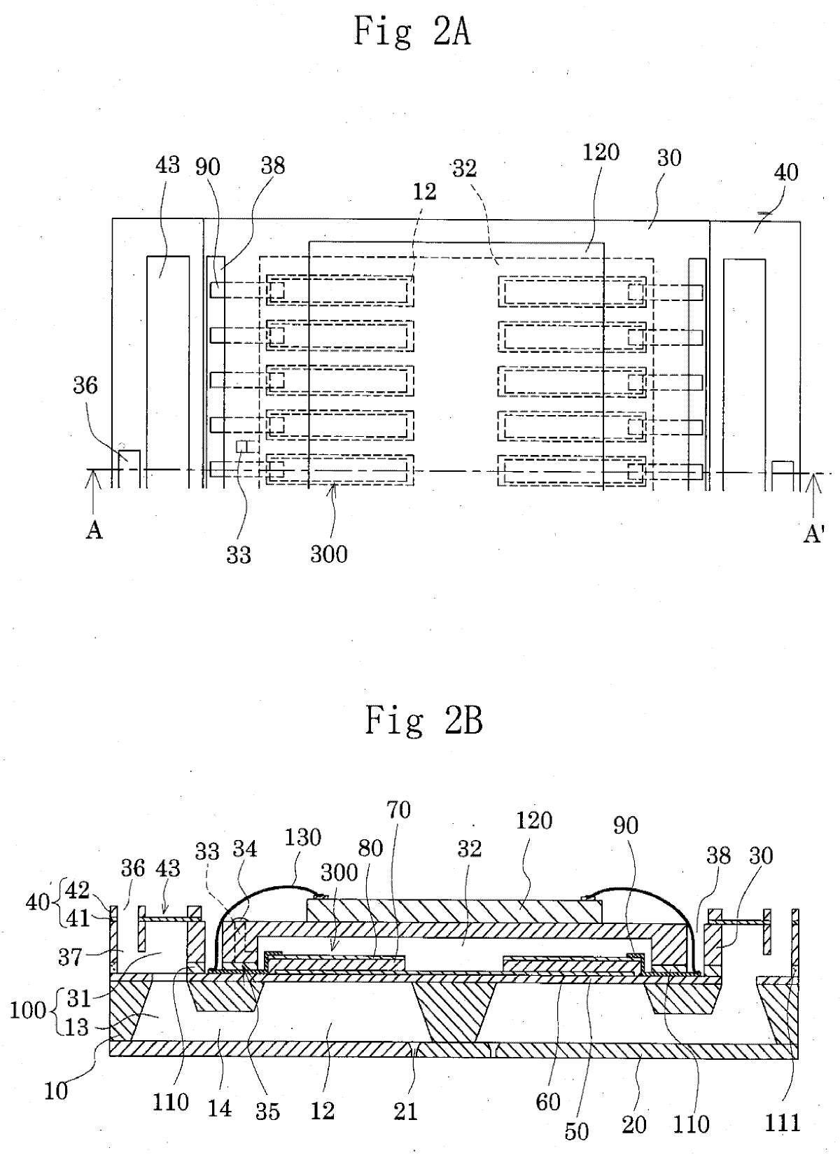

FIG. 1 is a perspective view showing an ink-jet recording head according to Embodiment 1 of the present invention. FIG. 2A is a plan view of FIG. 1 and FIG. 2B is a view showing a cross section along the line A-A′ in FIG. 2A.

As illustrated, a passage-forming substrate 10 is composed of a single crystal silicon substrate of a plane orientation (110) in this embodiment. As the passage-forming substrate 10, usually, one having a thickness of about 150 to 300 mm is used, and one desirably having a thickness of about 180 to 280 mm and more desirably having a thickness of about 220 mm is suitable. This is because an array density of the pressure generating chambers can be enhanced while keeping a rigidity of compartment walls between adjacent pressure generating chambers.

One surface of the passage-forming substrate 10 becomes an opening surface, and on the other surface, an elastic film 50 is formed, which is made of silicon dioxide formed by thermal oxidation in advance and has a thickness of 1 to 2 mm.

Meanwhile, on the opening surface of the passage-forming substrate 10, pressure generating chambers 12 partitioned by a plurality of compartment walls 11 are provided in parallel in the width direction by carrying out anisotropic etching to the single crystal silicon substrate. On the outside in a longitudinal direction of the pressure generating chambers 12, there are formed communicating portions 13, each communicating with a reservoir portion 31 of a sealing plate 30 to be described later and constituting a part of a reservoir 100 which will be a common liquid chamber to the respective pressure generating chambers 12. Each communicating portion 13 is made to communicate via ink supply paths 14 with one ends in the longitudinal direction of the respective pressure generating chambers 12.

Here, the anisotropic etching is carried out by utilizing a difference in etching rates of the single crystal silicon substrate. For example, in this embodiment, the anisotropic etching is carried out by utilizing the following property of the single crystal silicon substrate. Specifically, when the single crystal silicon substrate is immersed in an alkali solution such as KOH, it is gradually eroded, there emerge a first (111) plane perpendicular to the (110) plane and a second (111) plane forming an angle of about 70 degrees to the first (111) plane and an angle of about 35 degrees to the above-described (110) plane. As compared with an etching rate of the (110) plane, an etching rate of the (111) plane is about 1/180. With such anisotropic etching, it is possible to perform high-precision processing based on depth processing in a parallelogram shape formed of two of the first (111) planes and two of the second (111) planes slant thereto, and thus the pressure generating chambers 12 can be arranged in a high density.

In this embodiment, long sides of the respective pressure generating chambers 12 are formed of the first (111) planes, and short sides thereof are formed of the second (111) planes. These pressure generating chambers 12 are formed by etching the passage-forming substrate 10 until the etching almost penetrates through the passage-forming substrate 10 to reach the elastic film 50. Here, the elastic film 50 is eroded extremely little by the alkali solution used for etching the single crystal silicon substrate. Moreover, the respective ink supply paths 14 communicating with the one ends of the pressure generating chambers 12 are formed to be shallower than the pressure generating chambers 12, and thus passage resistance of ink flowing into the pressure generating chambers 12 is maintained constant. Specifically, the ink supply paths 14 are formed by etching the single crystal silicon substrate partway in the thickness direction (half-etching). Note that the half-etching is carried out by adjusting an etching time.

On the opening surface side of the passage-forming substrate 10, a nozzle plate 20 having nozzle orifices 21 drilled therein is fixedly adhered via an adhesive or a thermowelding film, each nozzle orifice 21 communicating with the pressure generating chamber 12 at a point opposite to the ink supply paths 14. Note that the nozzle plate 20 is made of glassceramics, stainless steel or the like, which has a thickness of, for example, 0.1 to 1 mm and a linear expansion coefficient of, for example, 2.5 to 4.5 [×10⁻⁶/° C.] at a temperature of 300° C. or lower. With one surface, the nozzle plate 20 wholly covers one surface of the passage-forming substrate 10 and also plays a role of a reinforcement plate for protecting the single crystal silicon substrate from an impact or an external force. Moreover, the nozzle plate 20 may be formed of a material having a thermal expansion coefficient approximately equal to that of the passage-forming substrate 10. In this case, since deformations of the passage-forming substrate 10 and the nozzle plate 20 due to heat become approximately the same, the passage-forming substrate 10 and the nozzle plate 20 can be joined easily to each other by use of a thermosetting adhesive and the like.

Here, a size of the pressure generating chambers 12 applying an ink droplet ejection pressure to ink and a size of the nozzle orifices 21 ejecting ink droplets are optimized in accordance with an amount of ejected ink droplets, an ejection speed thereof and an ejection frequency thereof. For example, in a case where 360 ink droplets per inch are recorded, it is necessary to form the nozzle orifices 21 in a diameter of several ten micrometers with good precision.

Meanwhile, on the elastic film 50 opposite with the opening surface of the passage-forming substrate 10, a lower electrode film 60 having a thickness of, for example, about 0.2 mm, a piezoelectric layer 70 having a thickness of, for example, about 1 mm, and an upper electrode film 80 having a thickness of, for example, about 0.1 mm are formed in a stacked state in a process to be described later, thus constituting a piezoelectric element 300. Here, the piezoelectric element 300 means a portion including the lower electrode film 60, the piezoelectric layer 70 and the upper electrode film 80. In general, the piezoelectric element 300 is constituted such that any one of electrodes thereof is made to be a common electrode, and that the other electrode and the piezoelectric layer 70 are patterned for each pressure generating chamber 12. Here, a portion, which is constituted of the patterned one of electrodes and the patterned piezoelectric layer 70, and where a piezoelectric distortion is generated by application of a voltage to both of the electrodes, is referred to as a piezoelectric active portion. In this embodiment, the lower electrode film 60 is made to be a common electrode of the piezoelectric element 300, and the upper electrode film 80 is made to be an individual electrode of the piezoelectric element 300. However, no impediment occurs even if the above-described order is reversed for the convenience of a drive circuit or a wiring. In any case, a piezoelectric active portion will be formed for each pressure generating chamber. In addition, here, a combination of the piezoelectric element 300 and a vibration plate in which displacement occurs due to the drive of the piezoelectric element 300 is referred to as a piezoelectric actuator.

Moreover, a lead electrode 90 made of, for example, gold (Au) and the like is extended from the vicinity of the one end portion in the longitudinal direction of the upper electrode film 80 of each piezoelectric element 300 to the vicinity of the end portion of the passage-forming substrate 10. Then, to the vicinity of the end portion of this lead electrode 90, drive wiring 130 for driving the piezoelectric element 300 is electrically connected.

On the side of the passage-forming substrate 10 where the piezoelectric elements 300 are formed, the sealing plate 30 having the reservoir portion 31 is joined, the reservoir portion 31 constituting at least a part of the reservoir 100 as a common liquid chamber. In this embodiment, the reservoir portion 31 is formed along the width direction of the pressure generating chambers 12 by penetrating the sealing plate 30 in its thickness direction. Thus, as described above, the reservoir portion 31 constitutes the reservoir 100 to be a common ink chamber for the pressure generating chambers 12 by communicating with the communicating portions 13 of the passage-forming substrate 10.

Moreover, in a region of the sealing plate 30 facing the piezoelectric elements 300, the piezoelectric element holding portion 32 is provided, which is capable of hermetically sealing a space secured in such a way that it does not hinder a movement of the piezoelectric elements 300. The piezoelectric elements 300 are hermetically sealed in this piezoelectric element holding portion 32.

Furthermore, a sealing hole 33 for communicating the piezoelectric element holding portion 32 with the outside is provided in the sealing plate 30, which is sealed by a sealing member 34 such as, for example, an adhesive.

Note that, for the sealing plate 30, it is preferable to use a material having approximately the same thermal expansion coefficient as that of the passage-forming substrate 10. In this embodiment, the sealing plate 30 is formed of a single crystal silicon substrate, which is the same material as the passage-forming substrate 10.

Across an entire surface of a joining surface 35 of the sealing plate 30 with the passage-forming substrate 10, a glass joining layer 110 made of glass is formed, by which the sealing plate 30 and the passage-forming substrate 10 are joined. Herein, as the glass for forming the glass joining layer 110, used is the one having a melting point of, for example, about 200 to 700° C., which is lower than a calcination temperature of a piezoelectric layer 70 constituting the piezoelectric elements 300. In this embodiment, the passage-forming substrate 10 and the sealing plate 30 are fused together by heating and melting the above-described glass joining layer 110 made of glass.

Note that there is no limitation on a thickness of the above-described glass joining layer 110. Since the lead electrode 90 is extended from the vicinity of the one end portion in the longitudinal direction of the upper electrode film 80 of the piezoelectric element 300 to the outside of the piezoelectric element holding portion 32, it is preferable that the thickness of the glass joining layer 110 is in the range of, for example, about 0.5 to 10 mm, which is equal to or somewhat greater than a thickness of the lead electrode 90.

By joining the passage-forming substrate 10 and the sealing plate 30 with the glass joining layer 110 interposed therebetween as described above, the intrusion of moisture into the piezoelectric element holding portion 32 is prevented without damage to the piezoelectric elements 300 due to heat, thus enabling satisfactory joining of the passage-forming substrate 10 and the sealing plate 30. Specifically, because no moisture in the atmosphere permeates the glass joining layer 110 made of glass, inside of the piezoelectric element holding portion 32 can be maintained in a dry state all the time. Consequently, the piezoelectric elements 300 in the piezoelectric element holding portion 32 are never damaged by the moisture in the atmosphere. Moreover, the damage to the piezoelectric elements 300 due to the moisture in the atmosphere can be more surely prevented by sealing a dry fluid and the like in the piezoelectric element holding portion 32 beforehand.

Furthermore, by fusing the sealing plate 30 and the passage-forming substrate 10 with the glass joining layer 110 made of glass interposed therebetween, both plates can be securely joined even though a joining area is relatively small. Thus, miniaturization of the ink-jet recording head can be achieved.

On such a sealing plate 30, a compliance plate 40 formed of a sealing film 41 and a fixing plate 42 is joined. Herein, the sealing film 41 is made of a material having flexibility with low rigidity (for example, a polyphenylene sulphide (PPS) film having a thickness of 6 mm), and one side surface of the reservoir portion 31 is sealed by this sealing film 41. Moreover, the fixing plate 42 is formed of a hard material such as metal (for example, stainless steel (SUS) having a thickness of 30 mm and the like). A region of this fixing plate 42, which faces the reservoir 100, is an opening portion 43 where the fixing plate is completely removed in its thickness direction. Thus, one side surface of the reservoir 100 is sealed only with the sealing film 41 having flexibility and can be deformed by a change in an internal pressure.

On the compliance plate 40 outside the center region of the reservoir 100 in the longitudinal direction, an ink introducing port 36 for supplying ink to the reservoir 100 is formed. Furthermore, in the sealing plate 30, an ink introducing passage 37 is provided for communicating the ink introducing port 36 with a side wall of the reservoir 100.

On a region of the sealing plate 30, which corresponds to the piezoelectric elements 300, a drive circuit 120 such as a semiconductor integrated circuit (IC) including, for example, a circuit board or a drive circuit for driving the piezoelectric elements 300 is mounted. The drive circuit 120 is electrically connected to the respective lead electrodes 90 by drive wirings 130 made of bonding wires and the like, which are provided in a region between the piezoelectric element holding portion 32 of the sealing plate 30 and the reservoir portion 31 and are extended via a through hole 38 (refer to FIG. 2B).

The ink-jet recording head of this embodiment as described above takes in ink from the ink introducing port 36 connected to unillustrated external ink supplying means, and fills the ink in the inside thereof from the reservoir 100 to the nozzle orifices 21. Then, in accordance with a recording signal from the drive circuit 120, the ink-jet recording head applies a voltage between the lower electrode film 60 and the upper electrode film 80, which correspond to each pressure generating chamber 12, and the elastic film 50, the lower electrode film 60 and the piezoelectric layer 70 are subjected to flexural deformation. Thus, the pressure in each pressure generating chamber 12 is increased, and ink droplets are ejected from each nozzle orifice 21.

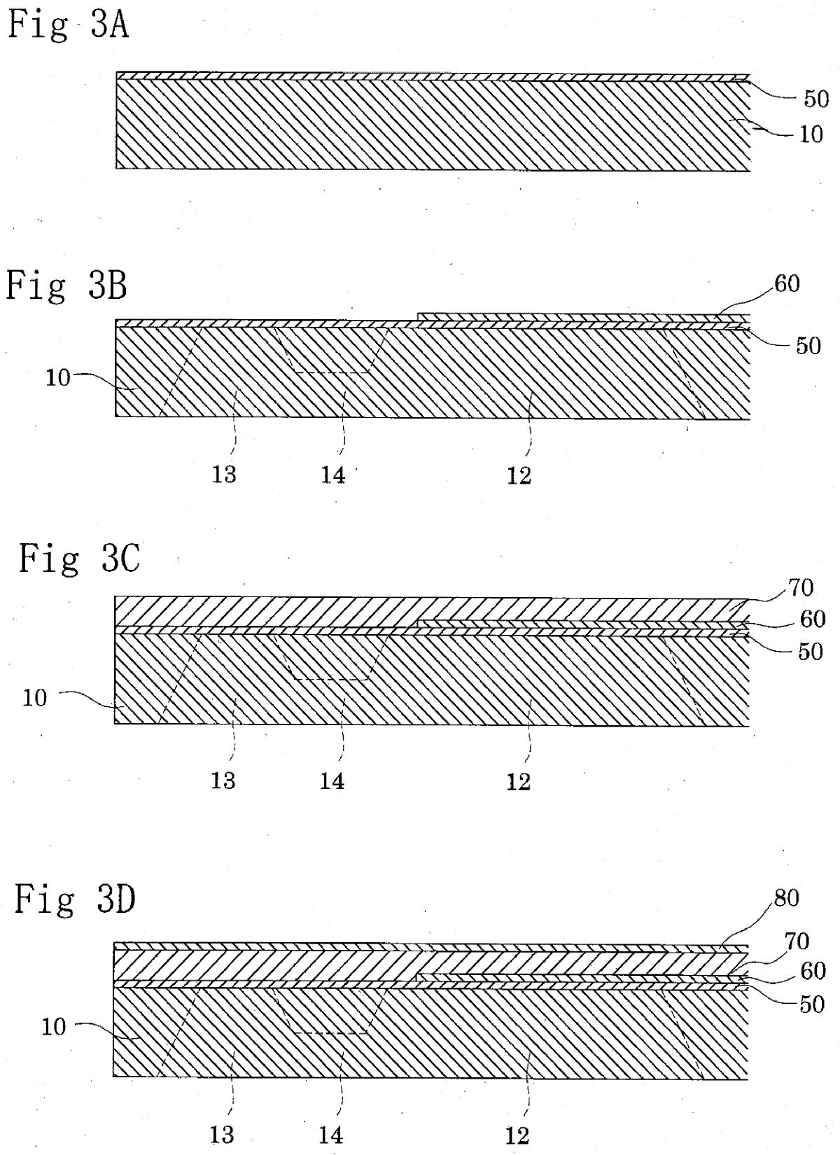

Referring to FIGS. 3 to 6, description will be made for an example of a method of manufacturing the ink-jet recording head of this embodiment described above. It should be noted that the manufacturing method thereof is not limited to the following example. FIGS. 3 to 6 are cross-sectional views illustrating a part of the pressure generating chamber 12 in the longitudinal direction.

First, as shown in FIG. 3A, a wafer of a single crystal silicone substrate to be the passage-forming substrate 10 is thermally oxidized in a diffusion furnace of about 1100° C., thereby forming the elastic film 50 made of silicone dioxide.

Next, as shown in FIG. 3B, after the lower electrode film 60 is formed on the entire surface of the elastic film 50 by sputtering, an overall pattern is formed by pattering the lower electrode film 60. For the material of this lower electrode film 60, platinum (Pt) and the like is preferred. This is because the piezoelectric layer 70 to be described later, which is deposited by a sputtering method or a solgel method, needs to be crystallized by baking at about 600 to 1000° C. under the atmospheric atmosphere or the oxygen atmosphere after deposition. Specifically, the material of the lower electrode film 60 has to be able to maintain conductivity at such a high temperature and under such an oxidation atmosphere. Particularly, when lead zirconate titanate (PZT) is used as the piezoelectric layer 70, it is preferable that a change in conductivity due to diffusion of lead oxide is small. In view of the above reasons, platinum is preferred for the material of the lower electrode film 60.

Then, as shown in FIG. 3C, the piezoelectric layer 70 is deposited on the resultant structure. In the piezoelectric layer 70, crystals are preferably oriented. In this embodiment, for example, by use of a so-called sol-gel method, the piezoelectric layer 70 was formed, in which the crystals are oriented. Specifically, in the sol-gel method, a metal-organic matter dissolved/dispersed in a catalyst, that is so-called a sol, is applied and dried to be a gel, and the gel is further baked at a high temperature, thus obtaining the piezoelectric layer 70 made of a metal oxide. For the material of the piezoelectric layer 70, one from lead-zirconate-titanate series is preferred for the use of manufacturing the ink-jet recording head. Note that there is particularly no limitation on a method of depositing the above-described piezoelectric layer 70, and a sputtering method, for example, may be used for the formation thereof.

Furthermore, a method may be used, in which a precursor film of lead zirconate titanate is formed by the sol-gel method, the sputtering method or the like, and thereafter, the precursor film is subjected to crystal growth in an alkaline solution at a low temperature by high-pressure processing.

In any case, the piezoelectric layer 70 thus deposited has priority orientation of crystals, unlike bulk piezoelectric elements. Moreover, in this embodiment, the piezoelectric layer 70 has its crystals formed in a columnar shape. Note that priority orientation means a state where orientation directions of crystals are not in disorder, but particular crystalline planes are directed in an approximately constant direction. Moreover, a deposition with columnar-shaped crystals means a state of deposited formation where roughly cylindrical crystals are aggregated along a plane direction of the deposited in a state of approximately coinciding central axes of the crystals in a thickness direction thereof. Needless to say, the piezoelectric layer may be a deposited formed of priority-oriented granular crystals. It should be noted that the piezoelectric layer thus fabricated in a deposited process has a thickness, in general, of 0.2 to 5 mm.

Next, as shown in FIG. 3D, the upper electrode film 80 is deposited on the piezoelectric layer 70. It is satisfactory that the upper electrode film 80 is made of a material having high conductivity. Many kinds of metal including aluminum, gold, nickel, platinum and the like and a conductive oxide can be used to form the upper electrode film 80. In this embodiment, platinum is deposited by sputtering.

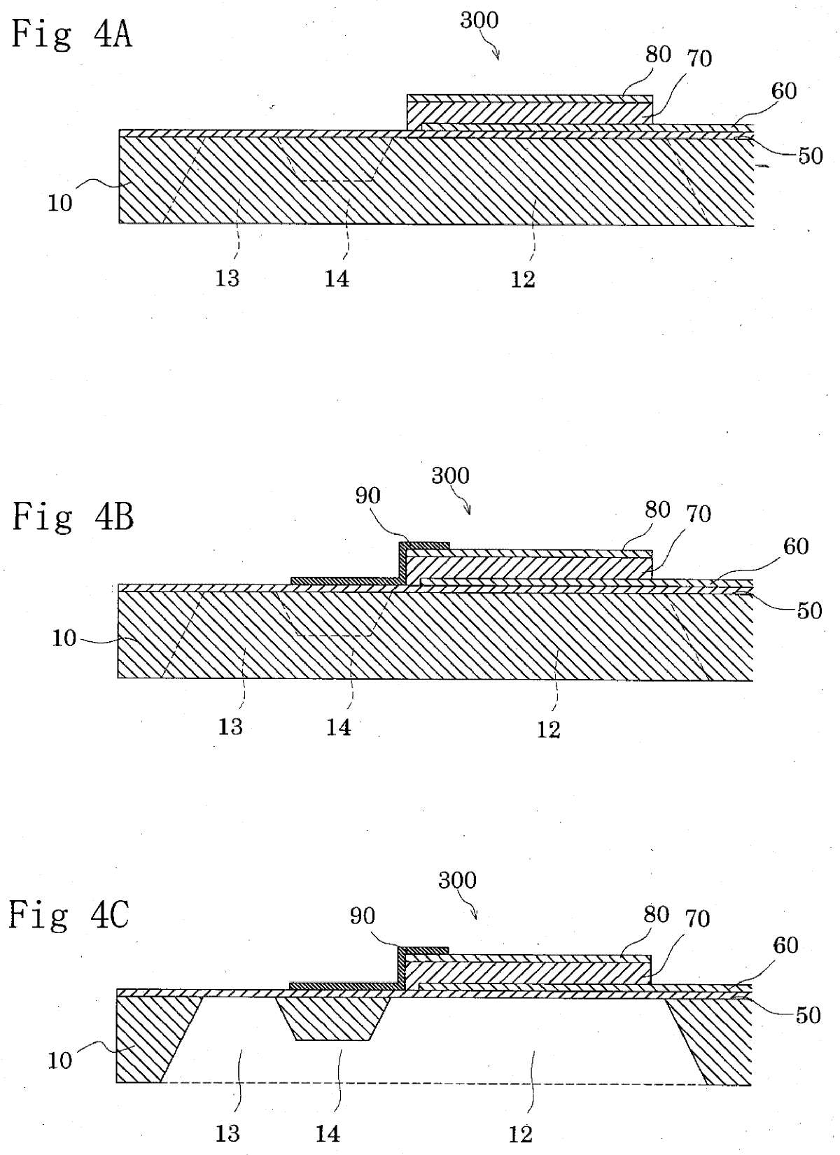

Subsequently, as shown in FIG. 4A, only the piezoelectric layer 70 and the upper electrode film 80 are etched to perform patterning of the piezoelectric element 300.

Thereafter, as shown in FIG. 4B, the lead electrode 90 is formed on the resultant structure. Specifically, the lead electrode 90 made of, for example, gold (Au) and the like is formed all over the entire surface of the passage-forming substrate 10, and at the same time, patterning thereof is performed for each piezoelectric element 300.

The above-described steps are the film formation process. After performing the film formation as described above, the foregoing anisotropic etching is carried out to the single crystal silicone substrate with the alkaline solution. Then, as shown in FIG. 4C, the pressure generating chamber 12, the communicating portion 13 and the ink supply path 14 are formed.

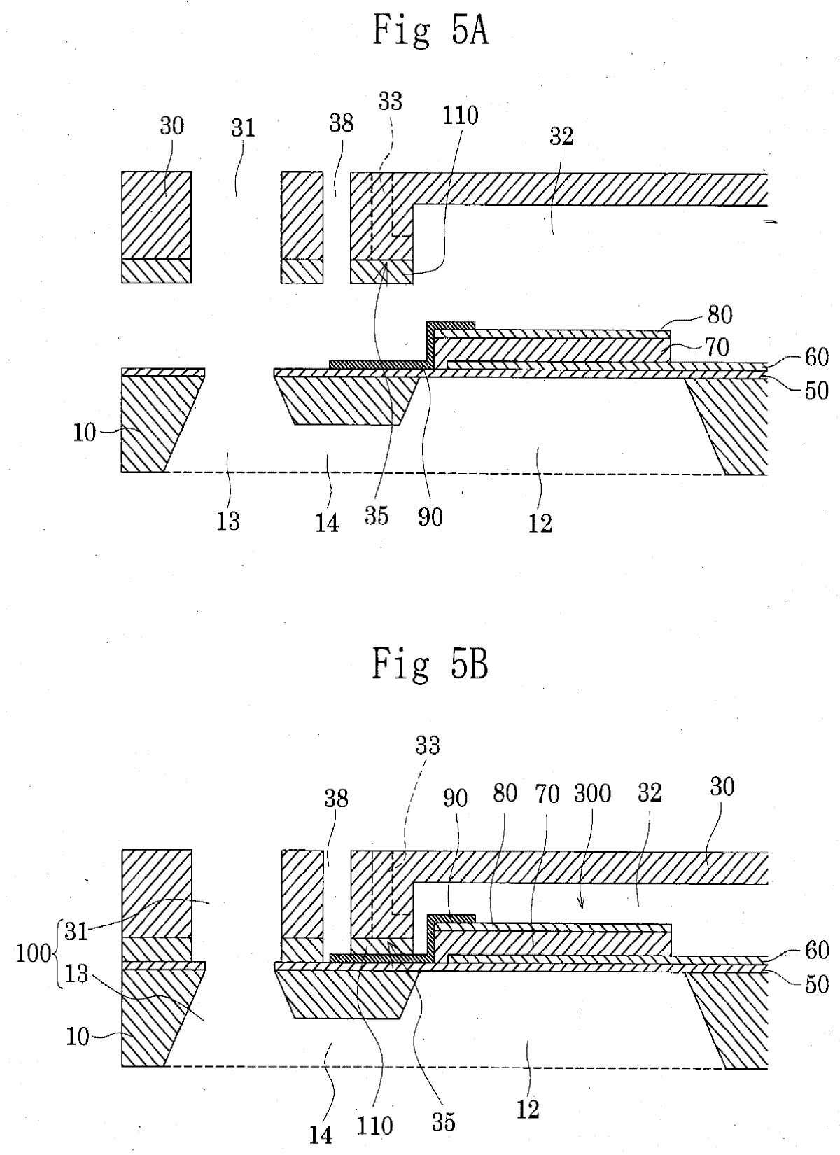

Next, as shown in FIG. 5A, on the joining surface 35 of the sealing plate 30 with the passage-forming substrate 10, formed is the glass joining layer 110 made of glass having a melting point lower than the calcination temperature of the piezoelectric layer 70 constituting the piezoelectric elements 300. Specifically, a glass material in paste form, which will be the glass joining layer 110, for example, is first applied onto the joining surface 35 of the sealing plate 30 by transcription, screen printing, a dispenser or the like, thus forming a glass layer thereon. Then, the glass layer is subjected to preliminary baking by being heated up to a temperature of about 200 to 400° C. Thereafter, a surface thereof is flattened, and the glass layer is subjected to degasification to become the glass joining layer 110.

Then, as shown in FIG. 5B, the sealing plate 30 and the passage-forming substrate 10 are joined together with the glass joining layer 110. Specifically, in a state wherein the two plates abut each other with the glass joining layer 110 interposed therebetween, both plates are heated to a temperature of, for example, about 200 to 700° C., which is equal to or lower than the crystallization temperature of the piezoelectric layer 70. Thus, the sealing plate 30 and the passage-forming substrate 10 are fused together by the glass joining layer 110.

As described above, by joining the passage-forming substrate 10 and the sealing plate 30 with the glass joining layer 110 made of glass having a melting point lower than the calcination temperature of the piezoelectric layer 70 constituting the piezoelectric elements 300, both plates are joined together at a temperature lower than the calcination temperature of the piezoelectric layer 70. Therefore, the damage to the piezoelectric elements 300 due to heat can be prevented, and the passage-forming substrate 10 and the sealing plate 30 can be satisfactorily joined together. Moreover, because of improvement in joining strength, both plates can be satisfactorily joined together even though a joining area is relatively small. Thus, miniaturization of the ink-jet recording head can be achieved.

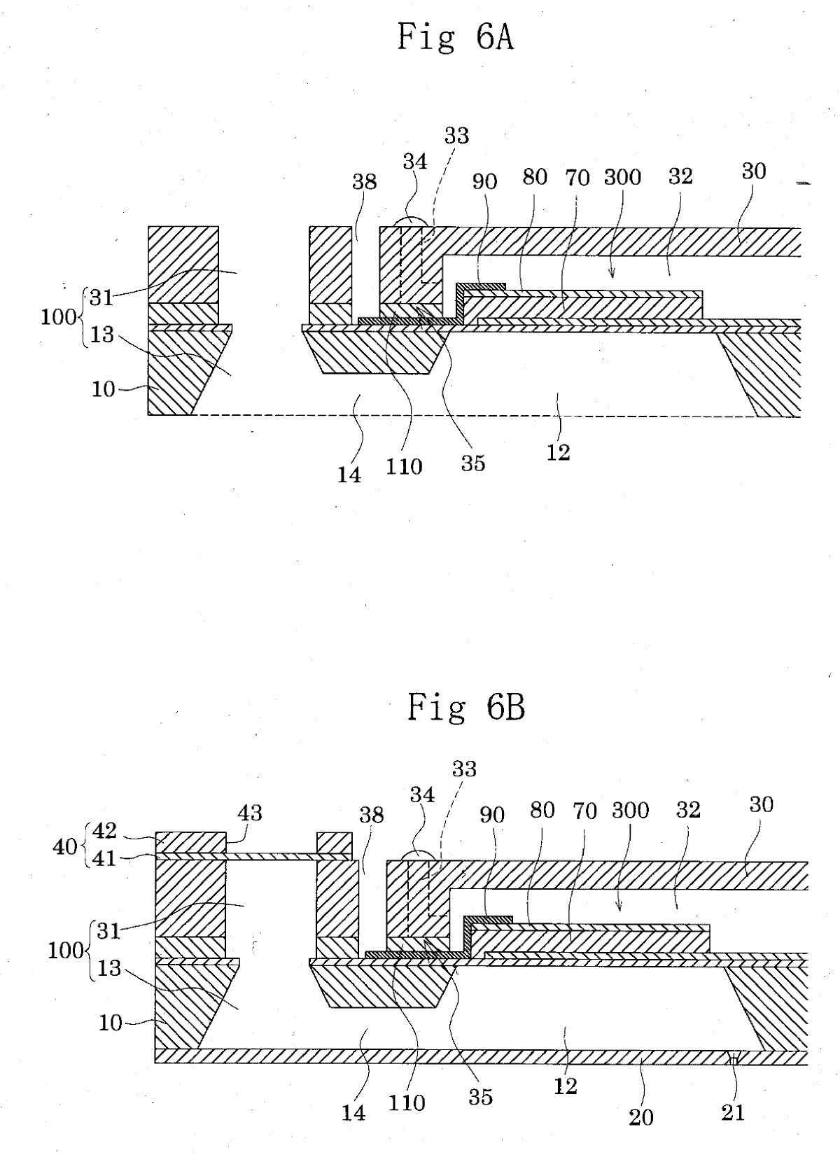

Next, as shown in FIG. 6A, the piezoelectric element holding portion 32 is hermetically sealed by sealing the sealing hole 33 which communicates the piezoelectric element holding portion 32 of the sealing plate 30 with the outside. In this embodiment, the sealing hole 33 is sealed by the sealing member 34 composed of, for example, an adhesive.

Thereafter, as shown in FIG. 6B, on the plane of the passage-forming substrate 10, which is opposite to the sealing plate 30, the nozzle plate 20 having nozzle orifices 21 drilled therein is joined. At the same time, the compliance plate 40 is joined on the sealing plate 30. Thus, the inkjet recording head of this embodiment is manufactured.

Note that, in practice, a number of chips are simultaneously fabricated on one piece of wafer by a series of the above-described film formation and anisotropic etching. Then, after the completion of the processing, the wafer is divided into passage-forming substrates 10 of one chip size as shown on FIG. 1. Thereafter, the sealing plate 30 and the compliance plate 40 are sequentially adhered onto the divided passage-forming substrate 10 to be unified, thus obtaining the ink-jet recording head.

(Embodiment 2)

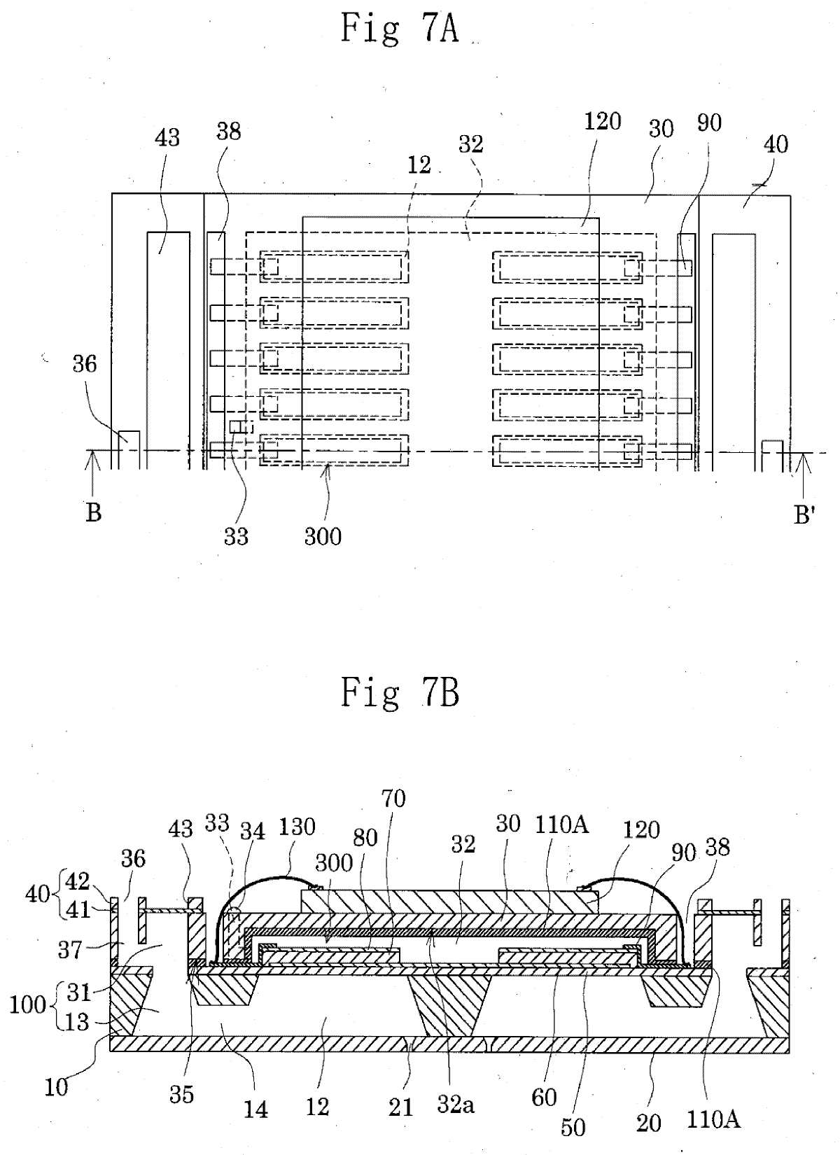

FIG. 7A is a plan view showing an ink-jet recording head according to Embodiment 2, and FIG. 7B is a view showing a cross-section taken along the line B-B′ in FIG. 7A.

As shown in the drawings, in this embodiment, a glass joining layer 110A made of glass is formed over the joining surface 35 of the sealing plate 30 with the passage-forming substrate 10 and an inner surface 32a of the piezoelectric element holding portion 32, and the sealing plate 30 and the passage-forming substrate 10 are joined by this glass joining layer 110A. Except for the above-described points, this embodiment is similar to the foregoing Embodiment 1.

For the glass used for the glass joining layer 110A of this embodiment, similarly to the above-described Embodiment 1, glass having a melting point of, for example, 200 to 700° C., which is lower than the calcination temperature of the piezoelectric layer 70, is also used.

As described above, by joining the passage-forming substrate 10 and the sealing plate 30 together with the glass joining layer 110A made of glass interposed therebetween, the damage to the piezoelectric elements 300 due to heat is prevented. Thus, both plates can be satisfactorily joined together by the glass joining layer 110A.

Moreover, by joining the passage-forming substrate 10 and the sealing plate 30 together with the glass joining layer 110A interposed therebetween, the intrusion of moisture into the piezoelectric element holding portion 32 can be surely prevented. Specifically, since the sealing plate 30 and the passage-forming substrate 10 are joined together by the glass joining layer 110A, the piezoelectric element holding portion 32 is completely and hermetically sealed. Thus, the moisture in the atmosphere and the ink in the reservoir 100 never permeate therethrough, enabling the inside of the piezoelectric element holding portion 32 to be maintained in a dry state all the time. Therefore, the damage to the piezoelectric elements 300 inside the piezoelectric element holding portion 32 due to the moisture never occurs.

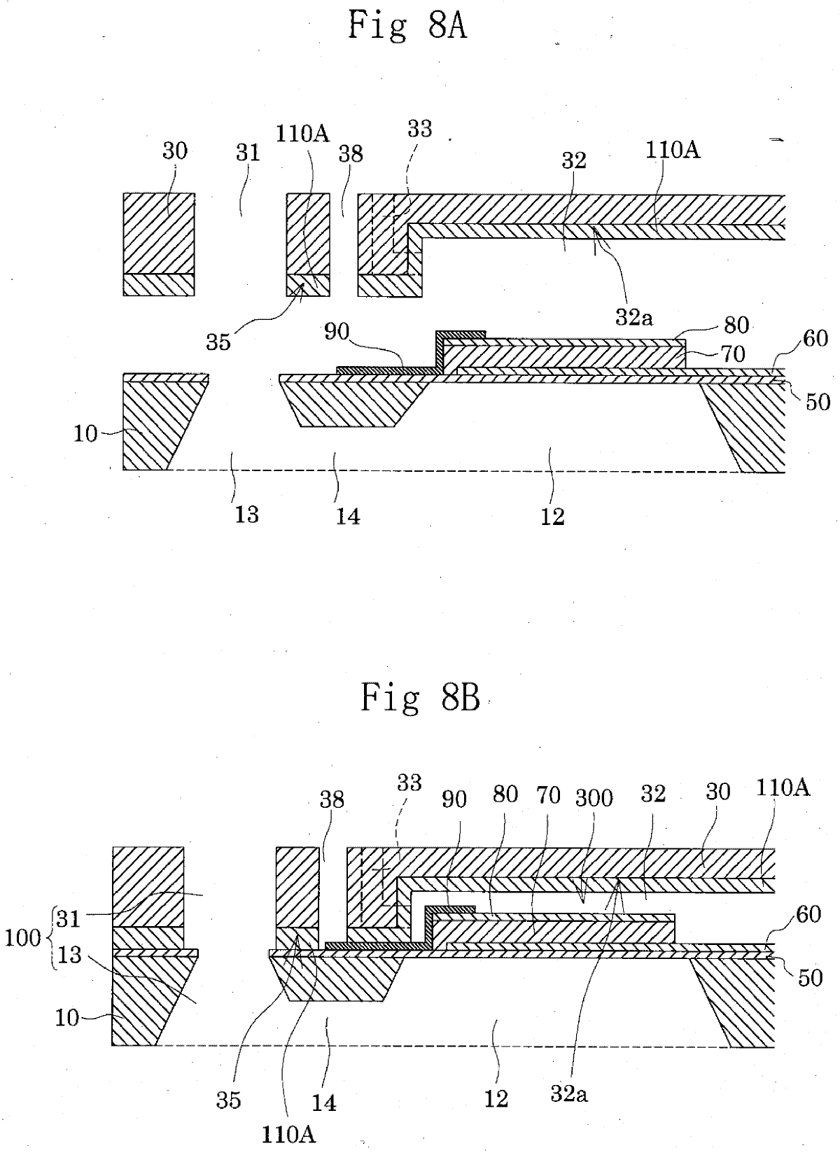

Herein, an example of a method of manufacturing the ink-jet recording head of this embodiment will be described by referring to FIGS. 8A and 8B. Note that, as to the manufacturing steps similar to those of the foregoing Embodiment 1, repetitive description thereof will be omitted by referring to the same drawings.

FIGS. 8A and 8B are cross-sectional views showing steps of manufacturing the ink-jet recording head according to Embodiment 2.

First, by performing the steps shown in FIGS. 3A to 3D and FIGS. 4A to 4C of the foregoing Embodiment 1, as well as the piezoelectric element 300 and the lead electrode 90, the pressure generating chamber 12, the communicating portion 13 and the ink supply path 14 are formed on the passage-forming substrate 10. Then, as shown in FIG. 8A, over the entire surface of the sealing plate 30 on the piezoelectric element holding portion 32 side, that is, over the joining surface 35 thereof with the passage-forming substrate 10 and the inner surface 32a of the piezoelectric element holding portion 32, the glass joining layer 110A made of glass is formed. Specifically, a glass film is first formed on a plane of the sealing plate 30 on the piezoelectric element holding portion 32 side, by sputtering or vacuum evaporation. Subsequently, the glass film is subjected to preliminary baking by being heated up to a temperature of about 200 to 400° C., and a surface thereof is flattened. Thereafter, the glass film is subjected to degasification, and thus the glass joining layer 110A is ultimately formed.

As shown in FIG. 8B, the sealing plate 30 and the passage-forming substrate 10 are then joined together by the glass joining layer 110A. Specifically, in a state wherein the two plates abut each other with the glass joining layer 110A interposed therebetween, both plates are heated to a temperature of, for example, about 200 to 700° C., which is equal to or lower than the crystallization temperature of the piezoelectric layer 70. Thus, the sealing plate 30 and the passage-forming substrate 10 are fused together by the glass joining layer 110A.

In the above-described manner, by forming the glass joining layer 110A on the sealing plate 30 by sputtering or vacuum evaporation, the glass joining layer 110A is formed all over the joining surface 35 of the sealing plate 30 with the passage-forming substrate 10 as well as the inner surface 32a of the piezoelectric element holding portion 32.

After the passage-forming substrate 10 and the sealing plate 30 are joined together, similarly to the foregoing Embodiment 1, the sealing hole 33 is sealed with the sealing member 34, and the piezoelectric element holding portion 32 is hermetically sealed. Then, the nozzle plate 20 having the nozzle orifices 21 drilled therein is joined on the plane of the passage-forming substrate 10, which is opposite to the sealing plate 30, and at the same time, the compliance plate 40 is joined on the sealing plate 30. Thus, the ink-jet recording head of this embodiment is formed.

(Embodiment 3)

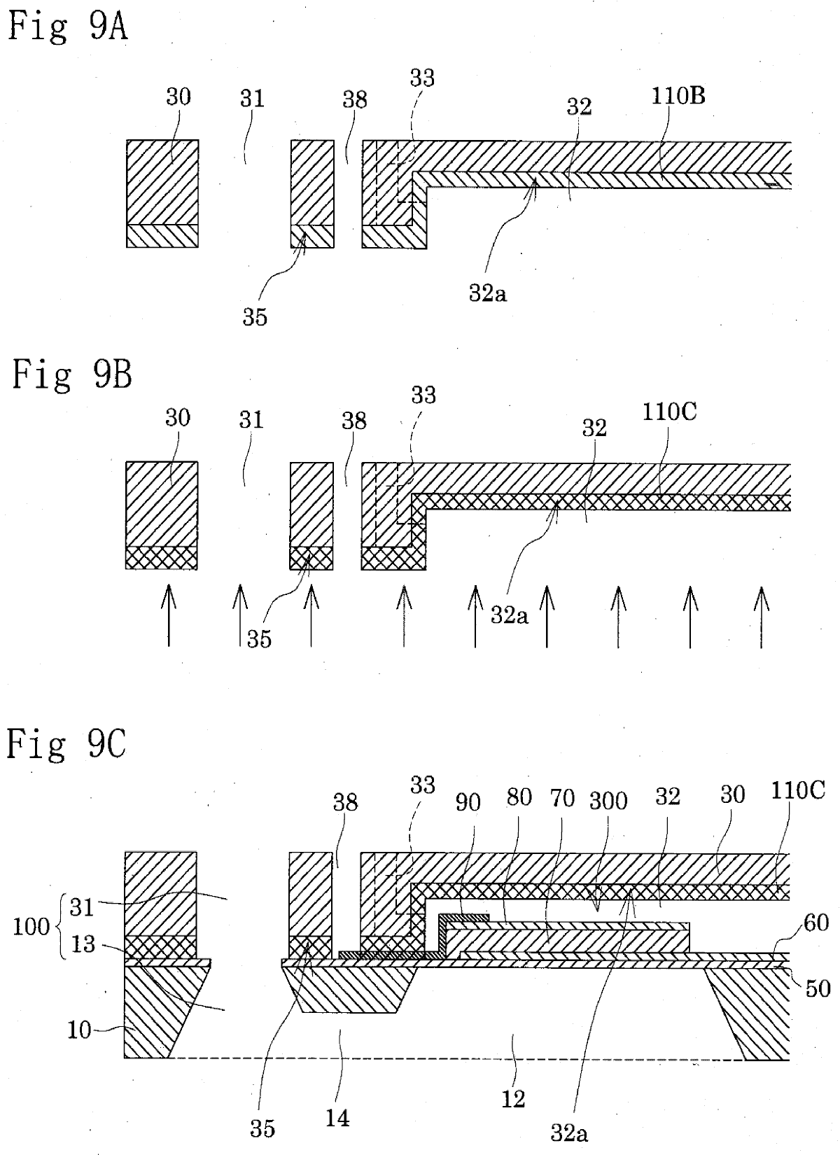

FIGS. 9A to 9C are cross-sectional views showing steps of manufacturing an ink-jet recording head according to Embodiment 3. Note that, in the manufacturing steps similar to those of the foregoing Embodiments 1 and 2, repetitive description thereof will be omitted by referring to the same drawings.

In this embodiment, the glass joining layer 110B is made to contain a gettering agent for trapping moisture, for example, phosphorous (P), and thus a glass joining layer 110C made of phosphorous-doped glass is obtained. Except for the above point, this embodiment is similar to the foregoing Embodiment 2.

As shown in FIG. 9A, the glass joining layer 110B is formed all over the plane of the sealing plate 30 on the piezoelectric element holding portion 32 side by sputtering or vacuum evaporation. Then, as shown in FIG. 9B, the glass joining layer 110B is doped with phosphorous (P) as the gettering agent, thus obtaining the glass joining layer 110C made of phosphorous-doped glass.

Thereafter, as shown in FIG. 9C, by performing the steps shown in FIGS. 3A to 3D and FIGS. 4A to 4C of the foregoing Embodiment 1, the piezoelectric element 300 and the lead electrode 90 are formed. In a state wherein the two plates abut each other with the glass joining layer 110C made of phosphorous-doped glass interposed therebetween, the passage-forming substrate 10 and the sealing plate 30 are heated, the passage-forming substrate 10 having the pressure generating chamber 12, the communicating portion 13 and the ink supply path 14 formed therein. Thus, the sealing plate 30 and the passage-forming substrate 10 are joined together by this glass joining layer 110C made of phosphorous-doped glass. That is, in a state wherein the two plates abut each other with the glass joining layer 110C interposed therebetween, both plates are heated to a temperature of, for example, about 200 to 700° C., which is equal to or lower than the crystallization temperature of the piezoelectric layer 70. Thus, the sealing plate 30 and the passage-forming substrate 10 are fused together by the glass joining layer 110C.

As described above, similarly to the foregoing embodiments, the intrusion of moisture into the piezoelectric element holding portion 32 can be prevented by joining the passage-forming substrate 10 and the sealing plate 30 together with the glass joining layer 110C made of phosphorous-doped glass. Moreover, in this embodiment, since the moisture remaining inside the piezoelectric element holding portion 32 is trapped by the gettering agent (phosphorous) contained in the glass joining layer 110C made of phosphorous-doped glass, inside of the piezoelectric element holding portion 32 is always maintained at a low humidity. Thus, the damage to the piezoelectric elements due to moisture can be more surely prevented.

In this embodiment, after the formation of the glass joining layer 110B on the surface of the sealing plate 30, the glass joining layer 110B is doped with phosphorous as the gettering agent, thereby forming the glass joining layer 110C made of phosphorous-doped glass. However, it should be noted that the method of adding the gettering agent is not limited to the above.

For example, when the glass joining layer 10C is formed by sputtering, the gettering agent may be previously added to the glass material, which is a target material for the sputtering. Moreover, when the glass joining layer is formed by vacuum evaporation, the gettering agent may be previously added to the glass material, which is a material for the vacuum evaporation.

When the gettering agent is previously added to the glass material as described above, the glass joining layer (phosphorous-doped glass) containing the gettering agent is formed by performing the steps of forming the glass joining layer by sputtering or vacuum evaporation, which are similar to those of Embodiment 2.

Moreover, in this embodiment, the whole region of the glass joining layer 110B is doped with phosphorous (P) as the gettering agent, thus obtaining the glass joining layer 110C made of phosphorous-doped glass. However, not being limited to the above, the gettering agent may be formed on the glass joining layer in a region corresponding at least to the inner surface 32a of the piezoelectric element 300.

After the passage-forming substrate 10 and the sealing plate 30 are joined together, similarly to the foregoing Embodiments 1 and 2, the sealing hole 33 is sealed with the sealing member 34, and the piezoelectric element holding portion 32 is hermetically sealed. Then, the nozzle plate 20 having the nozzle orifices 21 drilled therein is joined on the plane of the passage-forming substrate 10, which is opposite to the sealing plate 30, and at the same time, the compliance plate 40 is joined on the sealing plate 30. Thus, the ink-jet recording head of this embodiment is formed.

(Embodiment 4)

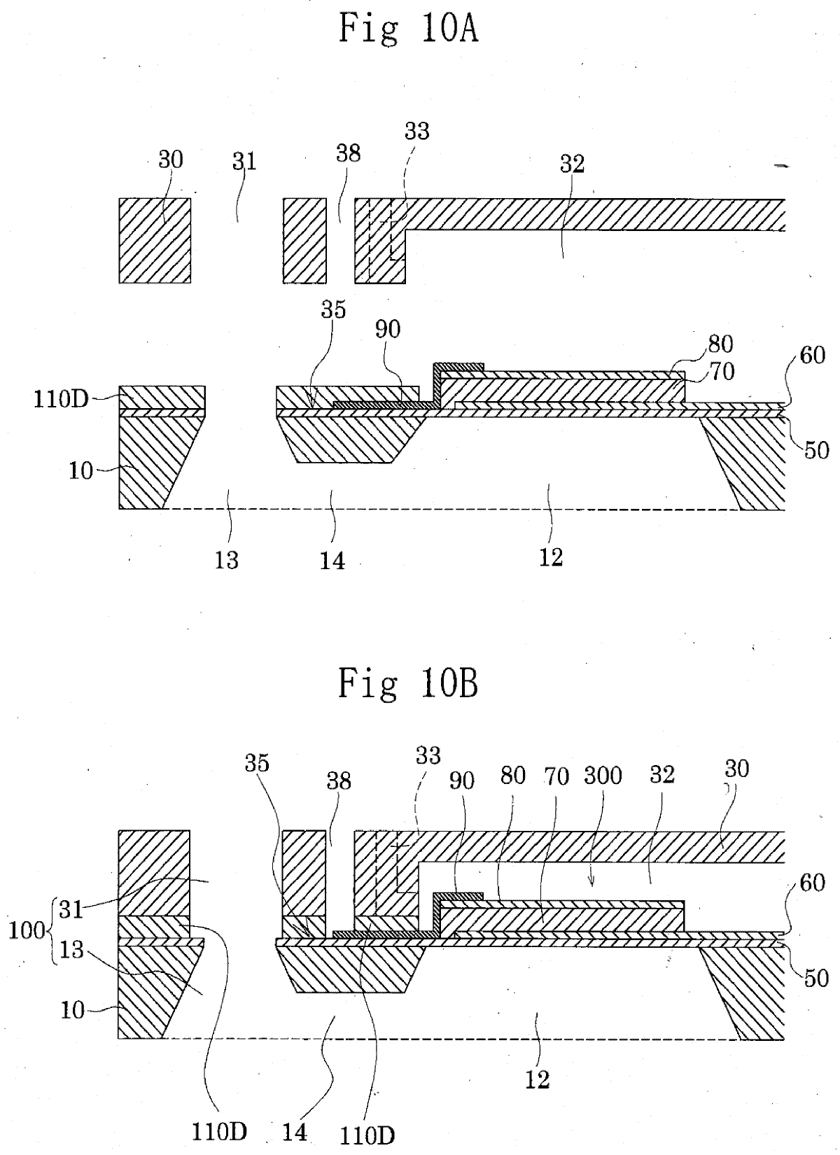

FIGS. 10A and 10B are cross-sectional views showing steps of manufacturing an ink-jet recording head according to Embodiment 4 of the present invention. Note that, as to the manufacturing steps similar to those of the foregoing Embodiments 1 to 3, repetitive description thereof will be omitted by referring to the same drawings.

In this embodiment, the passage-forming substrate 10 and the sealing plate 30 are joined together by forming a glass joining layer 110D made of glass containing a filler on the joining surface of the passage-forming substrate 10 with the sealing plate 30. Specifically, as shown in FIG. 10A, a glass layer is first formed on the joining surface 35 of the passage-forming substrate 10 by applying a glass material in paste form, in which a predetermined filler is previously contained, by transcription, screen printing, a dispenser or the like. Next, the glass layer is subjected to preliminary baking by being heated to a temperature of about 200 to 400° C., and a surface thereof is flattened. Then, the glass layer is subjected to degasification, thus obtaining the glass joining layer 110D.

For the filler contained in the glass joining layer 110D, enumerated are, for example, titania (TiO₂), zirconia (ZrO₂), alumina (Al₂O₃) and the like. By allowing the glass joining layer 110D to contain such a filler, thermal expansion coefficient of the glass joining layer 110D becomes equal to that of the passage-forming substrate 10 and the sealing plate 30.

Next, as shown in FIG. 10B, the sealing plate 30 and the passage-forming substrate 10 are joined together by the glass joining layer 110D. In other words, in a state wherein the two plates abut each other with the glass joining layer 110D interposed therebetween, both plates are heated to a temperature of, for example, about 200 to 700° C., which is equal to or lower than the crystallization temperature of the piezoelectric layer 70. Thus, the sealing plate 30 and the passage-forming substrate 10 are fused together by the glass joining layer 110D.

In the above-described manner, the glass joining layer 110D is allowed to contain the foregoing filler and to have the equal thermal expansion coefficient to that of the passage-forming substrate 10 and the sealing plate 30. Accordingly, it is possible to prevent damage to the glass joining layer 110D due to the thermal expansion caused by heating in joining the passage-forming substrate 10 and the sealing plate 30.

Moreover, by allowing the glass joining layer 110D to contain the filler, the glass joining layer 110D can be formed relatively thick, which is made of glass having a melting point lower than the calcination temperature of the piezoelectric layer 70. As a result, in the case where there is a bump on the joining surface 35 of the passage-forming substrate 10, even if the surfaces of the lead electrode 90 and the elastic film 50 are different in height, for example, at the joining surface 35 of the passage-forming substrate 10 with the sealing plate 30, the glass joining layer 110D can be hermetically adhered to the sealing plate 30 by flattening its surface. Accordingly, secure joining of the passage-forming substrate 10 and the sealing plate 30 can be carried out.

Furthermore, by using the glass joining layer 110D containing the filler, the strength of the glass joining layer 110D can be improved, thus enabling more secure joining of the passage-forming substrate 10 and the sealing plate 30.

Note that, after the joining of the passage-forming substrate 10 and the sealing plate 30, similarly to the foregoing Embodiments 1 to 3, the sealing hole 33 is sealed with the sealing member 34, and the piezoelectric element holding portion 32 is hermetically sealed. Then, the nozzle plate 20 having the nozzle orifices 21 drilled therein is joined on the plane of the passage-forming substrate 10, which is opposite to the sealing plate 30, and at the same time, the compliance plate 40 is joined on the sealing plate 30. Thus, the ink-jet recording head of this embodiment is formed.

(Embodiment 5)

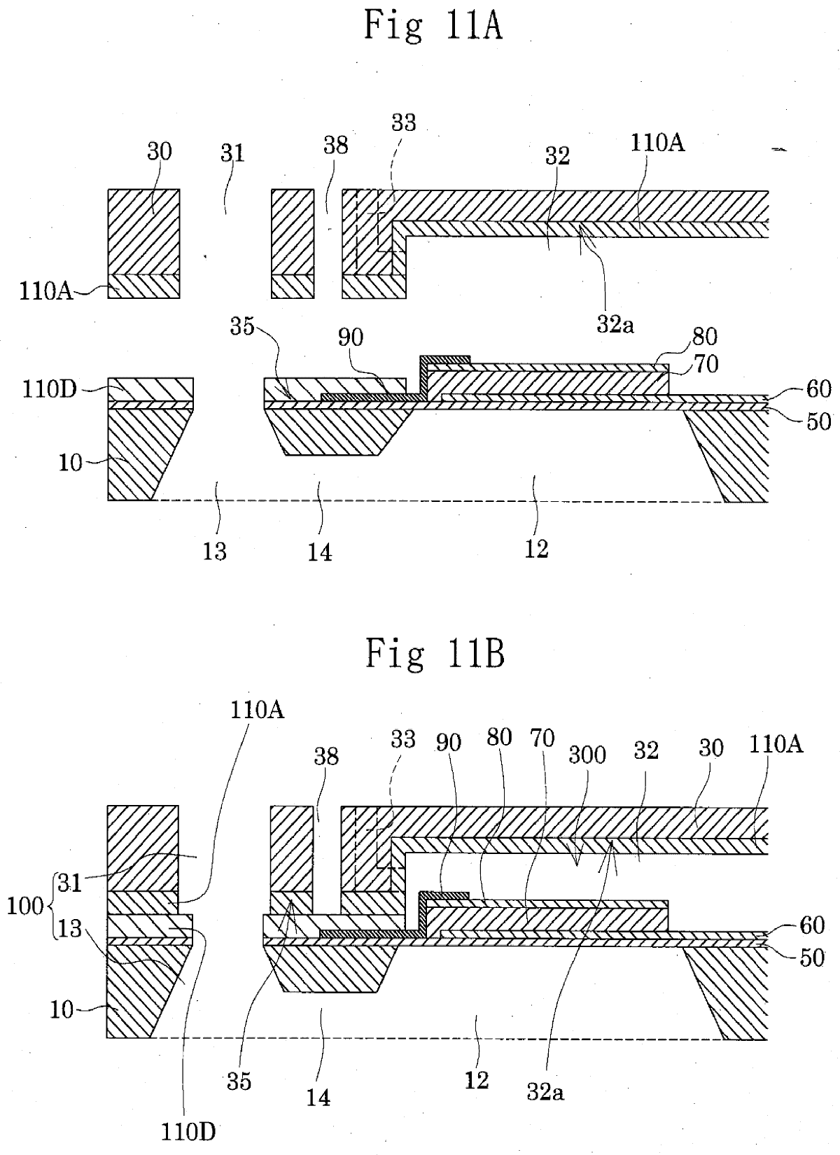

FIGS. 11A and 11B are cross-sectional views showing steps of manufacturing an ink-jet recording head according to Embodiment 5.

This embodiment is an example of joining the passage-forming substrate 10 and the sealing plate 30 by forming glass joining layers on the respective surfaces of both plates.

To be specific, as shown in FIG. 11A, the glass joining layer 110A is formed, similarly to the foregoing Embodiment 2, on the joining surface 35 of the passage-forming substrate 10 with the sealing plate 30 by sputtering or vacuum evaporation. Then, similarly to the foregoing Embodiment 4, the glass joining layer 110D is formed on the joining surface 35 of the passage-forming substrate 10 with the sealing plate 30 by transcription, screen printing, a dispenser or the like.

Then, as shown in FIG. 11B, the sealing plate 30 and the passage-forming substrate 10 are joined together by the glass joining layers 110A and 110D. In other words, in a state wherein the two plates abut each other, the glass joining layers 110A and 110D are heated to a temperature of, for example, about 200 to 700° C., which is equal to or lower than the crystallization temperature of the piezoelectric layer 70, and thus both layers are fused together. As a result, the sealing plate 30 and the passage-forming substrate 10 can be fused together.

As described above, by joining the passage-forming substrate 10 and the sealing plate 30 with the glass joining layers 110A and 110D interposed therebetween, respectively, the strength of the joining therebetween can be further improved. Accordingly, the moisture in the atmosphere and the reservoir 100 can be prevented more surely from intruding inside of the piezoelectric element holding portion 32. Note that, after the joining of the passage-forming substrate 10 and the sealing plate 30, similarly to the foregoing Embodiments 1 to 4, the sealing hole 33 is sealed with the sealing member 34, and the piezoelectric element holding portion 32 is hermetically sealed. Then, the nozzle plate 20 having the nozzle orifices 21 drilled therein is joined on the plane of the passage-forming substrate 10, which is opposite to the sealing plate 30, and at the same time, the compliance plate 40 is joined on the sealing plate 30. Thus, the ink-jet recording head of this embodiment is formed.

(Embodiment 6)

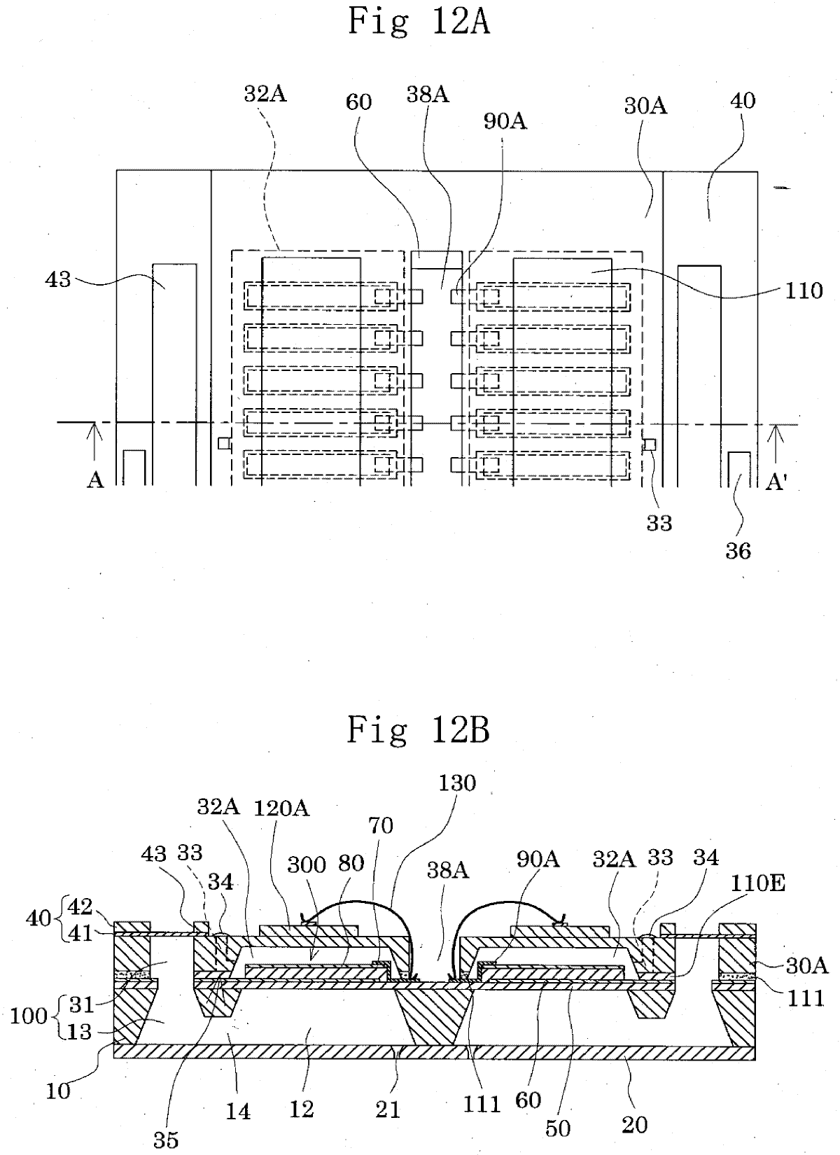

FIGS. 12A and 12B are a plan view and a cross-sectional view of the ink-jet recording head according to Embodiment 6.

As shown in FIGS. 12A and 12B, on a sealing plate 30A, piezoelectric element holding portions 32A are provided independently for each row of the piezoelectric elements 300. Between two piezoelectric holding portions, a through hole 38A penetrating in a thickness direction of the piezoelectric element 300 is provided.

Moreover, on the passage-forming substrate 10, a lead electrode 90A is pulled out from one end of the upper electrode film 80 of the piezoelectric element 300, and is provided so as to be partially exposed to the through hole 38A.

Furthermore, the lower electrode film 60 is provided in a region other than that of the lead electrode 90A, that is, over a space other than the space between the rows of the piezoelectric elements 300 provided in parallel.

Then, on the sealing plate 30A, two drive circuits 120A are provided, which drive for each row, corresponding to the rows of the piezoelectric elements 300 provided in parallel. Each drive circuit 120A and the lead electrode 90A are electrically connected to each other via a drive wiring 130 provided by being inserted through the through hole 38A.

Moreover, a glass joining layer 110E is provided only on the side of the reservoir portion 31 in a peripheral portion of the piezoelectric element holding portion 32A on the joining surface 35 between the passage-forming substrate 10 and the sealing plate 30A. In a region other than the above, an adhesion layer 111 made of, for example, a thermoplastic adhesive is provided.

The passage-forming substrate 10 and the sealing plate 30A are joined together by the glass joining layer 110E and the adhesion layer 111.

As described above, if the glass joining layer 110E is provided on the side of the reservoir portion 31 in the peripheral portion of the piezoelectric element holding portion 32A, where moisture is most likely to intrude into the piezoelectric element holding portion 32A, the intrusion of the moisture into the piezoelectric element holding portion 32A from the reservoir portion 31 side can be prevented, thus enabling the damage to the piezoelectric elements 300 to be prevented.

Particularly, when the piezoelectric element holding portion 32A and the reservoir portion 31 are provided adjacently to each other on the sealing plate 30A as in this embodiment, the moisture is likely to intrude into the piezoelectric element holding portion 32A from the reservoir 31. However, the provision of the glass joining layer 110E therebetween can prevent the damage to the piezoelectric elements 300 due to the moisture.

Note that, although the glass joining layer 110E is provided between the piezoelectric element holding portion 32A and the reservoir portion 31 in this embodiment, the damage to the piezoelectric elements 300 due to the moisture in the external environment can be also prevented by providing the glass joining layer over the peripheral portion of the piezoelectric element holding portion 32A. In such a case, regions other than the peripheral portion of the piezoelectric element holding portion 32A may be joined together by the adhesion layer.

(Other Embodiment)

Although the embodiment of the present invention has been described as above, the basic constitution of the ink-jet recording head is not limited to the ones described above.

For example, a dry fluid such as an inactive gas may be filled in the piezoelectric element holding portions 32 and 32A in the foregoing Embodiments 1 to 6.

In the case where the dry fluid is filled in the piezoelectric element holding portions 32 and 32A as described above, when the sealing hole 33 is sealed by the sealing member 34, for example, a joining body, in which the passage-forming substrate 10 and the sealing plates 30 and 30A are joined together, is disposed under decompression. Then, after reducing the pressure inside the piezoelectric element holding portion 32 and 32A, the joining body is disposed under an atmosphere of the dry fluid, thus enabling the dry fluid to be filled in the piezoelectric element holding portions 32 and 32A. By sealing the sealing hole 33 with the sealing member 34 in the above-described state, the piezoelectric element holding portion 32 and 32A can be hermetically sealed in the state of filling the dry fluid in the piezoelectric element holding portions 32 and 32A.

Moreover, for example, in the foregoing embodiment, exemplified is a deposited type ink-jet recording head, which is manufactured by adopting deposition and a lithography process. However, needless to say, the present invention is not limited by the above example. For example, the present invention can be employed in a thick-film type ink-jet recording head, which is formed by a method of attaching a green sheet and the like.

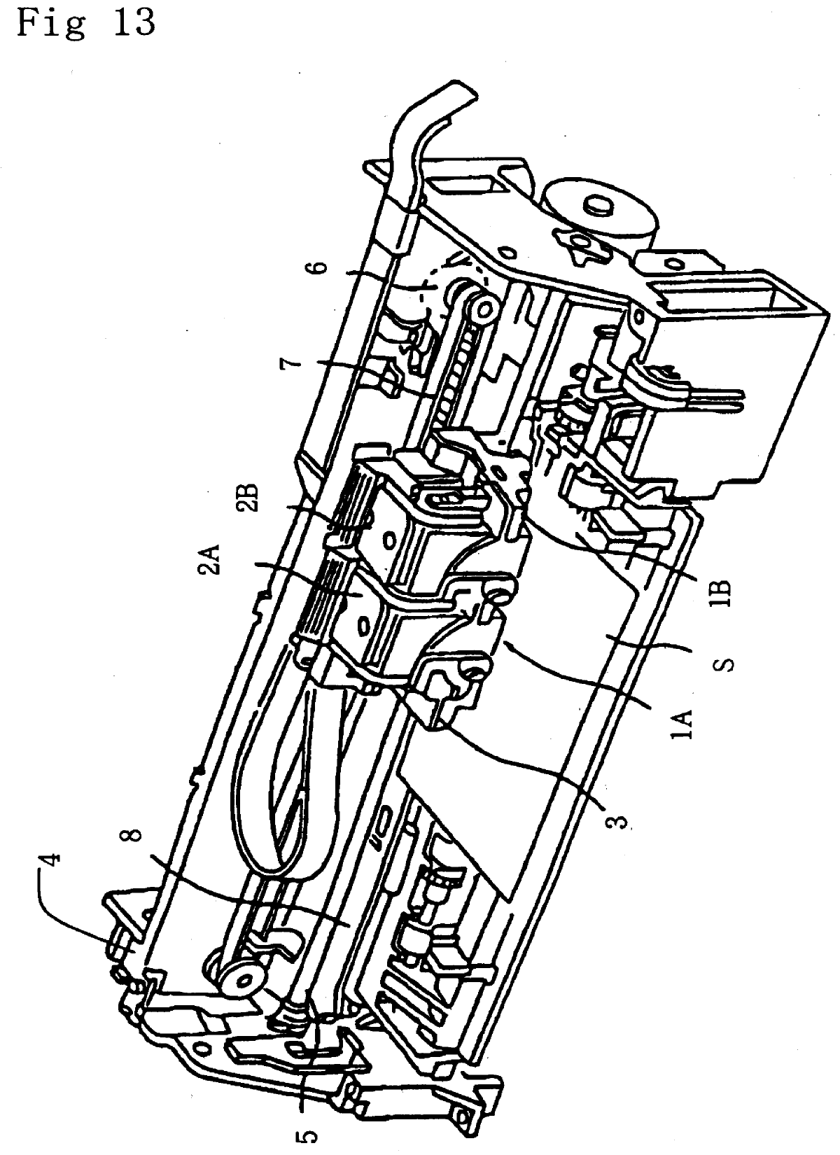

Moreover, the ink-jet recording head of each embodiment constitutes a part of a recording head unit, in which an ink flow path communicating with an ink cartridge and the like is provided, and is mounted on an ink-jet recording apparatus. FIG. 13 is a schematic view showing an example of the ink-jet recording apparatus.

As shown in FIG. 13, in recording head units 1A and 1B having ink-jet recording heads, cartridges 2A and 2B constituting ink supply means are provided detachably. A carriage 3 on which the recording head units 1A and 1B are mounted is provided on a carriage axle 5 fixed to an apparatus body 4, the carriage being provided movably in an axle direction. The recording head units 1A and 1B are intended to eject, for example, a black-ink composition and a color-ink composition, respectively.

A driving force of a drive motor 6 is transmitted to the carriage 3 via a plurality of gears (not shown) and a timing belt 7. Accordingly, the carriage 3, on which the recording head units 1A and 1B are mounted, is moved along the carriage axle 5. Meanwhile, a platen 8 is provided along the carriage axle 5 in the apparatus body 4, and a recording sheet S is conveyed on the platen 8, the recording sheet being a recording medium such as paper supplied by a nonillustrated supply roller and the like.

Note that the ink-jet recording head, which serves as a liquid-jet head and ejects ink, the manufacturing method thereof and the ink-jet recording apparatus have been described as an example. However, the present invention is the one widely targeted at the liquid-jet head, the manufacturing method thereof and the liquid-jet apparatus, in general. As the liquid-jet head, enumerated are, for example: a recording head used in an image recording apparatus such as a printer; a color material-jet head used in manufacturing a color filter such as a liquid crystal display; an electrode material-jet head used for electrode formation in an organic EL display, a FED (field emission display) and the like; a bio-organic jet head used in manufacturing a bio chip; and the like.

As described above, in the present invention, since the passage-forming substrate and the sealing plate having the piezoelectric element holding portion are fused together by the glass joining layer made of glass. Accordingly, the moisture in the atmosphere and the reservoir never intrudes into the piezoelectric element holding portion via the glass joining layer. Therefore, damage to the piezoelectric elements due to the moisture can be surely prevented.

Moreover, in order to improve the strength of the joining, the joining area between the passage-forming substrate and the sealing plate can be made relatively small. Thus, the miniaturization of the recording head can be achieved.

1. A liquid-jet head, including a passage-forming substrate in which a pressure generating chamber communicating with a nozzle orifice ejecting a liquid is defined, and a piezoelectric element composed of a lower electrode, a piezoelectric layer and an upper electrode on one surface of the passage-forming substrate with a vibration plate interposed therebetween, the liquid-jet head comprising: a sealing plate joined towards a piezoelectric element side of the passage-forming substrate and having a piezoelectric element holding portion, the sealing plate hermetically sealing a space secured in a region facing to the piezoelectric element in such a way that it does not hinder a movement thereof, wherein:
at least a part of a peripheral portion of the piezoelectric element holding portion of the sealing plate is joined to the passage-forming substrate via a glass joining layer made of glass, and
the glass joining layer is formed over an inner surface of the piezoelectric element holding portion.

2. The liquid-jet head according to claim 1, wherein the glass constituting the glass joining layer contains a gettering agent for trapping moisture.

3. The liquid-jet head according to claim 2, wherein the gettering agent contains phosphorous.

4. The liquid-jet head according to claim 1, wherein the glass constituting the glass joining layer contains a filler.

5. The liquid-jet head according to claim 4, wherein the filler is made of at least one kind selected from a group including titania, zirconia and alumina.

6. A liquid-jet apparatus comprising the liquid-jet head according to claim 1.
